(19) United States
(12) Patent Application Publication
(10) Pub. No.: US 2006/0077256 A1
(43) Pub. Date: Apr. 13, 2006

(54) High resolution pre-event record

(76) Inventors: William Bradford Silvemail, Raleigh, NC (US); Jody Snow, Gamer, NC (US); Olivier Singla, Apex, NC (US); Ray C. Henry, Wake Forest, NC (US)

Correspondence Address: John L. Sotomayor, Suite 300, 511 Davis Drive, Morisville, NC, 27560, US

(21) Appl. No.: 11/288,190

(22) Filed: Nov. 29, 2005

Related U.S. Application Data
(63) Continuation-in-part of application No. 10/703,258, filed on Nov. 7, 2003.
(60) Provisional application No. 60/709,111, filed on Aug. 18, 2005.

(51) Int. Cl. H04N 7/18; H04N 9/47

(52) U.S. Cl. 348/143

(57) ABSTRACT

The High Resolution Pre-Event Record system is an innovative means for collecting audio, video, and meta-data in a mobile vehicle platform and continuously recording this information stream to a high-capacity storage device at different levels of data resolution based upon the status of a trigger event. The occurrence of a trigger event will cause the system to store higher resolution data to an on-board high-capacity storage device prepended by a configurable amount of high resolution data previously recorded into a pre-event data buffer. The data stream may later be downloaded to an external storage device for future review and analysis.

This application is a Continuation-in-part of co-pending application Ser. No. 10/703,258 which was filed Nov. 7, 2003, and claims priority to U.S. provisional application serial No. 60/709,111 which was filed Aug. 18, 2005.

### BACKGROUND OF THE INVENTION

In mobile security and surveillance systems that record video and audio, the ability to provide a buffer of information prior to a trigger event is known. However, current recording systems typically record video at single resolution during any given time period, either low-resolution or high-resolution, and also typically have no ability to modify the resolution of the recording regardless of the importance of the event to be captured except under manual control. In addition, current systems typically record in an intermittent fashion, for example a patrol car that records data only when an event occurs or only as required under manual control. The problem of recording continuously and switching the resolution of recording from lower resolution to a higher resolution as needed to capture an event, or even recognizing an event that triggers such a switch in recording resolution, are not addressed by the current pre-event recording solutions implemented primarily as periodic recording systems.

The present invention addresses these problems, as well as issues of implementing a system under full programmatic control for automated data capture based upon trigger events. The current invention provides an elegant solution that captures an integrated data stream of recorded data in a continuous fashion, switching resolution to capture events that trigger a need for higher resolution recording, and recording the integrated data stream for later review and analysis.

### TECHNICAL FIELD

The present invention is directed toward a means for preferentially recording a high resolution integrated stream of data composed of audio, video, and meta-data based upon a trigger event within a mass transit vehicle, the integrated stream of data being saved to an on-board high-capacity storage device.

### SUMMARY OF THE INVENTION

The invention is installed within a mass transit vehicle such as, for example, a city bus, train, or school bus in which a low resolution integrated steam of data delivered from a Digital Signal Processor (DSP), an audio codec, and another internal meta-data source is continuously being recorded to a high-capacity storage device. Simultaneously, a high resolution instance of the same integrated data stream is being stored to a circular data buffer of configurable length. Upon experiencing a trigger event, the high resolution integrated stream of data replaces the low resolution data stream thus improving the quality of the recorded data stream stored to the high-capacity storage device. In addition, a buffer containing a configurable quantity of the integrated data stream recorded from the circular data buffer prior to the trigger event is prepended to the high resolution recording. In this fashion, the recorded data stream contains a high-quality, high resolution integrated data stream from a time prior to the trigger event and continuing through to the end of the time period for recording required by the trigger event. At the expiration of the set trigger event record time period, the system reverts to the steady-state operation of the low resolution integrated data stream being recorded directly to the high-capacity storage device, and the high resolution integrated data stream being recorded into the configurable length circular data buffer.

The integrated data stream, in both normal and event modes, is stored to an on-board high-capacity storage device and later downloaded to an external high-capacity storage device to free storage in the on-board high-capacity storage device for reuse.

### BRIEF DESCRIPTION OF THE DRAWINGS

The above objects and advantages of the present invention will become more apparent by describing in detail preferred embodiments thereof with reference to the attached drawings, in which:

FIG. 1: illustrates the control software that starts, monitors, and stops the system

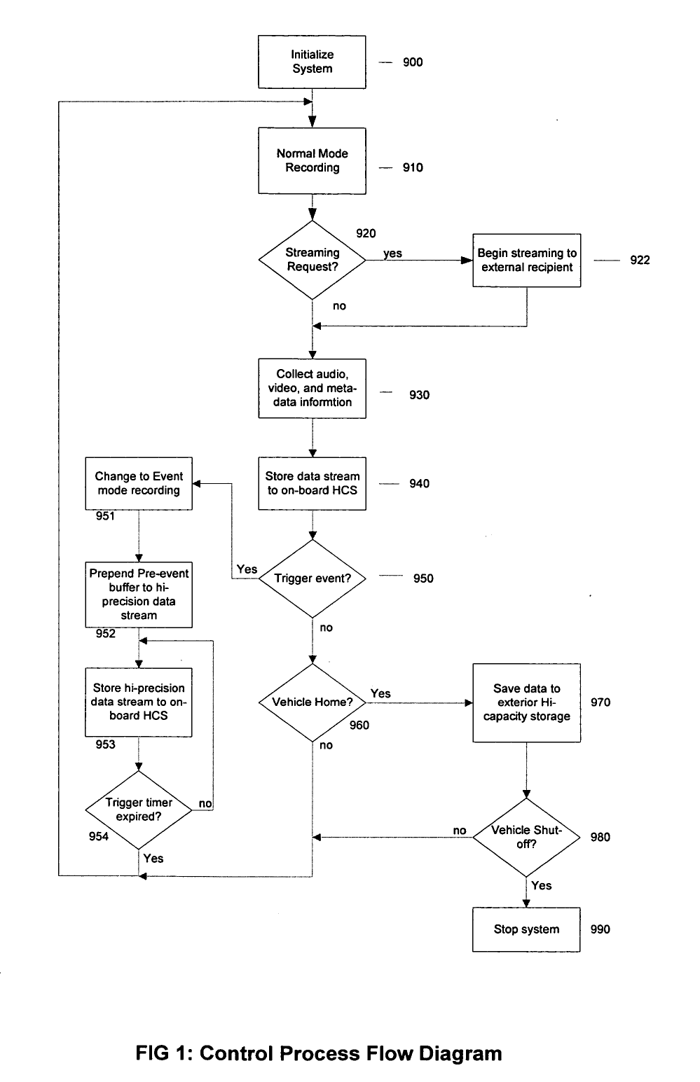

FIG. 2: illustrates the steady-state, or normal, mode for system operation

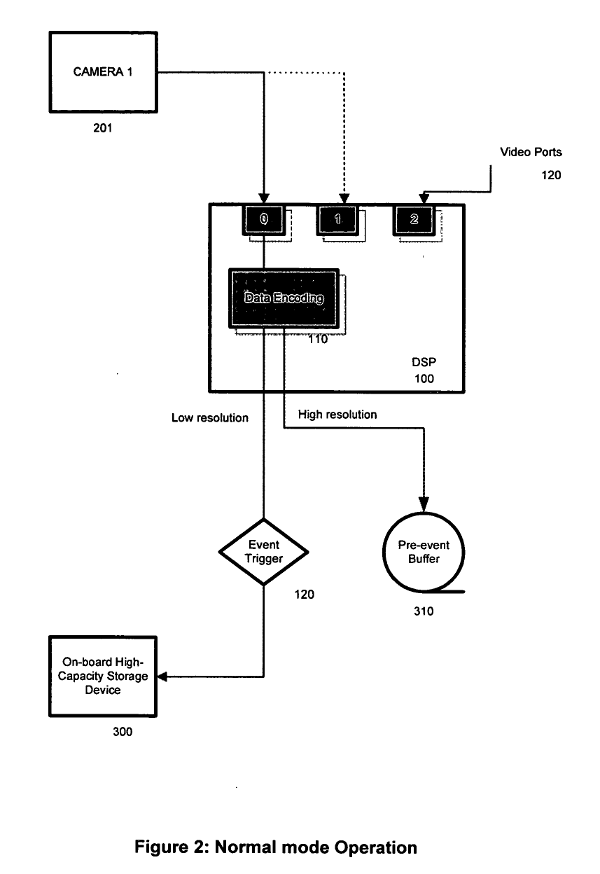

FIG. 3: illustrates the event mode of system operation after a trigger event

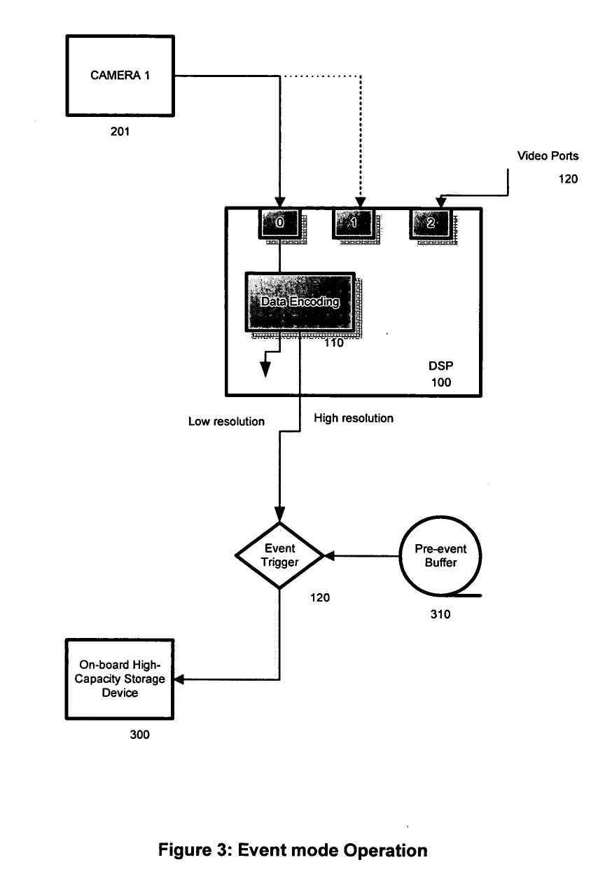

### DETAILED DESCRIPTION

The High-Quality Pre-event Record function collects an integrated stream of information consisting of audio, video, textual data and meta-data information and stores this information stream to a high-capacity storage device located on-board a mass transit vehicle such as a security vehicle, city bus, train, or school bus. The recorded integrated data stream receives video data from a Digital Signal Processor (DSP) 100 that receives input and provides output from at least one digital video camera 201. The application module that controls the process of receiving output from the DSP 100, creates the integrated data stream and records said data information stream into a high-capacity storage (HCS) 300 device is the transitcam application.

When the transitcam application is running the Mobile Digital Video Recorder (MDVR) is continuously recording. The system records data in two modes; a normal mode 910 and an event mode 951.

The system can record the integrated data stream at three levels of resolution, each level of which is configurable based upon a combination of parameters shown below. The resolution levels are low-resolution, medium-resolution, and high-resolution and are set as system configuration variables by the system administrator. The resolution level is set as a combination of the following parameter settings:
Frames per second rate (between 1 and 30)
Bitrate (in bits/second)
Rate Control: VBR (Variable Bit Rate) or CBR (Constant Bit Rate)
Compression algorithm: ISO-MPEG4 SP/ASP/AVC, ITU-H.263
Scene Complexity: Hi, Low or Medium
Image Resolution: D1, Half-D1, VGA, SIF, etc.
Number of key frames per second

Because the parameters combining to form a resolution level are configurable, high-resolution recording files have the greatest visual clarity and largest recorded file size. Medium-resolution recorded files are grainer in terms of visual clarity and recorded file sizes are smaller than those of high-resolution recordings. Low-resolution recorded files have the grainiest visual clarity and smallest file sizes of each of the levels of resolution. With this characterization in mind, the user is free to define low, medium, and high resolution levels as any combination of the above parameters that preserves the relationship of low, medium, and high resolution data information recording.

As an example, an administrator of the system could choose to record low-resolution video at the rate of 5 frames per second. This frame rate produces a choppy video steam, but saves a great amount of space in the on-board HCS 300 allowing a larger mean time between downloads for the HCS 300. The administrator could then set the high-resolution video record rate at 30 frames per second, requiring much larger files to be stored on the HCS 300, but also providing real-time recording quality for the length of the event timer(s).

### NORMAL MODE

Upon system initialization 900 the system begins operating in normal mode 910. The system begins collecting audio, video, and meta-data information 930, combining the video data information from Camera 1 201 with input audio and meta-data information into an integrated data information stream and storing the integrated data information stream in an HCS 300 device 940 located on-board the mass transit vehicle. This data information stream is defined as being either low-resolution or medium-resolution. There is a trade off between recorded quality and file size. Although the quality is lower, low-resolution or medium-resolution data information stream files are stored directly to the HCS 300 during normal mode because they are smaller and allow for a larger number of files to be stored in the HCS 300, providing a longer time for recording before the HCS 300 must be downloaded into external storage, freeing the HCS 300 to begin accepting new data information files.

Simultaneously, a high-resolution data information stream is being recorded from Camera 1 201 through data encoding means within a DSP 100 and into a circular buffer of configurable length, called the Pre-event buffer 310. The length of the buffer may be set to store between 1 and n number of seconds (n is typically between 30 and 180) of data information stream files based upon the needs of the user. This guarantees that only a fixed amount of storage in the HCS 300 will be consumed by the larger data information stream files generated by high-resolution recording. When the end of the data buffer 310 is reached, the data information stream files are written to the beginning of the buffer 310 once again, overwriting the previous data information stream files and progressing through the buffer 310 once again in circular fashion.

Therefore, during normal mode 910 operation, the system records one lower-resolution data information stream in the HCS 300 and one higher-resolution data information stream in the pre-event circular buffer 310.

### EVENT MODE

When a trigger event occurs 950, the system changes the recording mode to event mode 951. Trigger events are defined within the system database as those events that a user of the system is interested in capturing in high-resolution for later analysis and possible evidentiary use. The system has a database and a rules engine module for storing a plurality of trigger event definitions and deciding, based upon input operational characteristics and meta-data captured by the system, when the threshold for a stored trigger event has been reached. Once a trigger event threshold has been met, a trigger event is declared and the system changes the recording mode to event mode 951.

In this mode, the high resolution data information stream recorded by Camera 1 201 is stored in the HCS 300. The Low Resolution recording for Camera 1 201 is not retained on the HCS 300. In addition to the high resolution recording from Camera 1 201, the integrated data stream information that has been previously stored in the pre-event buffer 310 is saved to the HCS 300 device prior to the high-resolution recorded information from Camera 1 201. The integrated data stream is encoded by the DSP into at least two resolution levels, a high resolution and a lower resolution. For example, the two resolution levels may be accomplished through the use of a video splitter to feed the same camera output to two instances of the compression algorithm resident within the DSP 100 or by transcoding or transrating encoding of the higher resolution data so as to generate the lower resolution data as a result of the encoding process thus conserving DSP 100 resources. As stated above, high resolution integrated data files are characterized as those having a larger recorded file size than low resolution integrated data files. The desired recording resolution for each level of encoding is selectable by the system administrator or other designated user. The combination of the high-resolution recording output from Camera 1 201 and the contents of the pre-event buffer 310 are saved in the high-capacity storage 300 device as a set of files that are referenced as a single event.

At the expiration of a timer associated with said trigger event 954, the system returns to recording data information in normal mode. If a second event occurs prior to the expiration of the first event timer, the timer is reset to its original value to capture the second event in its entirety. The system returns to normal mode recording at the expiration of any or all overlapping event timers.

Moving saved data files from the on-board HCS 300 to an exterior High-capacity storage 970 is accomplished when the mass transit vehicle stops at a facility equipped with a Transitcam Video Management Server (TVMS) and high-capacity storage equipment. This transfer is accomplished in one of two methods; (1) physically removing the on-board HCS 300 from the mass transit vehicle or (2) transmitting the saved data files from the on-board HCS 300 to the TVMS over wired or wireless data communication means.

In the first method, the on-board HCS 300 is contained in a ruggedized, removable enclosure that is electrically connected to the on-board MDVR. When the mass transit vehicle returns to a maintenance facility, the driver or other designated user physically removes the on-board HCS 300 enclosure and transports said enclosure into the facility. The user then inserts the on-board HCS 300 enclosure into a rack-mounted slot designed to receive said enclosure. The rack-mounted slot maintains an electrical connection to a system server. The on-board HCS 300, when inserted into the rack-mounted slot, is electrically connected to the system server through a dedicated connector located within said rack-mounted slot. Once the on-board HCS 300 achieves electrical connection with the system server, the user presses a toggle switch to initiate the process within the system server to transfer all data files from the on-board HCS 300 to the external high-capacity storage 970.

In the second method, when the mass transit vehicle returns to a maintenance facility, the driver or other designated user will connect a network communications wire to establish network communications from the on-board MDVR processor to the TVMS located within the maintenance facility. Alternatively, the MDVR may establish a wireless networked communication connection with the TVMS located within the maintenance facility. Once communication has been established, the on-board MDVR processor initiates the transfer process through a software module dedicated to file transfer to transfer all data files from the on-board HCS 300 to the TVMS and the associated storage device.

Regardless of whether the above method 1 or method 2 is used for data transfer, if the mass transit vehicle must leave the maintenance facility before all of the files have been transferred from the on-board HCS 300, the files that have not been successfully transferred are maintained within the on-board HCS 300 and will not be overwritten. When the mass transit vehicle returns once again to the maintenance facility, said maintained files are the first files to be transferred to the TVMS and the associated high-capacity storage device.

While this invention has been particularly shown and described with reference to preferred embodiments thereof, it will be understood by those skilled in the art that various changes in form and details may be made therein without departing from the spirit and scope of the invention as defined by the appended claims.

We claim:

1. A mobile digital video recording surveillance system installed within a public transport vehicle comprising:
a plurality of data capture devices for continuously capturing video, audio, and meta-data comprising at least two separate data streams;
a memory device including a permanent memory area and a memory buffer to permanently store a first one of said captured data streams in said permanent memory area and temporarily store a second one of said captured data streams in said memory buffer;
a trigger device to monitor the operational environment for pre-configured trigger event conditions;
a logic device pre-configured to switch recording from a first data stream to a second data stream and directing said second data stream to said permanent memory area in the presence of a trigger event;
a timer set for a pre-configured duration which is initiated upon reception of a trigger event;
wherein the system continues to capture and record said second data stream during the duration of said timer and, at the termination of said timer duration, switches said second data stream recording to said memory buffer and resumes recording said first data stream to said permanent memory area.

2. A mobile digital video recording surveillance system according to claim 1 further comprising:
a device for recording a first data stream at a lower data resolution than a second data stream.

3. A mobile digital video recording surveillance system according to claim 1 further comprising:
a logic device pre-configured to record data in a normal mode and an event mode, wherein the system records data in normal mode until a trigger event occurs and then the system switches to event mode.

4. A mobile digital video recording surveillance system according to claim 3 further comprising:
a logic device pre-configured to record data from a first data stream to a permanent data area and to record data from a second data stream to a temporary memory buffer area when recording in normal mode;
wherein said lower resolution first data stream is recorded to a permanent memory area during normal mode as a means for conserving space in a digital memory device.

5. A mobile digital video recording surveillance system according to claim 3 further comprising:
a logic device pre-configured to record data from a second data stream to a permanent data area when recording in event mode;
wherein said higher resolution second data stream is recorded to a permanent memory area during the presence of a trigger event as a means for providing a higher quality recorded data stream for later evidentiary use.

6. A mobile digital video recording surveillance system according to claim 5 further comprising:
A logic device pre-configured to record the data stream from the memory buffer into the permanent memory area prior to recording said second data stream in the presence of a trigger event.

7. A mobile digital video recording surveillance system according to claim 1 further comprising:
A logic device pre-configured to extend the duration of time limit for an event upon the indication of a subsequent trigger event received prior to the expiration of the time limit for a previous trigger event.

8. A process for initiating a mobile digital video recording surveillance system installed within a public transport vehicle to record a preferred data stream comprising:
continuously capturing video, audio, and meta-data comprising at least two separate data streams;
initiating a permanent memory area and a memory buffer to permanently store a first one of said captured data streams in said permanent memory area and temporarily store a second one of said captured data streams in said memory buffer;
monitoring the operational environment for pre-configured trigger event conditions;
directing said second data stream to said permanent memory area in the presence of a trigger event;
setting a timer for a pre-configured duration which is initiated upon reception of a trigger event;
wherein the system continues to capture and record said second data stream during the duration of said timer and, at the termination of said timer duration, switches said second data stream recording to said memory buffer and resumes recording said first data stream to said permanent memory area.

9. A process according to claim 8 further comprising:
recording a first data stream at a lower data resolution than a second data stream.

10. A process according to claim 8 further comprising:
recording data in a normal mode and an event mode, wherein the system records data in normal mode until a trigger event occurs and then the system switches to event mode.

11. A process according to claim 10 further comprising:
recording data from a first data stream to a permanent data area and recording data from a second data stream to a temporary memory buffer area when recording in normal mode;
wherein said lower resolution first data stream is recorded to a permanent memory area during normal mode as a means for conserving space in a digital memory device.

12. A process according to claim 10 further comprising:
recording data from a second data stream to a permanent data area when recording in event mode;
wherein said higher resolution second data stream is recorded to a permanent memory area during the presence of a trigger event as a means for providing a higher quality recorded data stream for later evidentiary use.

13. A process according to claim 12 further comprising:
recording the data stream from the memory buffer into the permanent memory area prior to recording said second data stream in the presence of a trigger event.

14. A process according to claim 8 further comprising:
extending the duration of time limit for an event upon the indication of a subsequent trigger event received prior to the expiration of the time limit for a previous trigger event.
